(19) United States
(12) Patent Application Publication
(10) Pub. No.: US 2017/0297483 A1
(43) Pub. Date: Oct. 19, 2017

(54) AUTOMATED DISPLAY OF "IN CASE OF EMERGENCY" INFORMATION VIA INFOTAINMENT HARDWARE

(71) Applicant: Panasonic Automotive Systems Company of America, Division of Panasonic Corporation of North America, Peachtree City, GA (US)

(72) Inventors: SAURIN DESAI, SUWANEE, GA (US); ERIC WILLIAMS, JR., ATLANTA, GA (US)

(73) Assignee: Panasonic Automotive Systems Company of America, Division of Panasonic Corporation of North America

(21) Appl. No.: 15/487,712

(22) Filed: Apr. 14, 2017

Related U.S. Application Data
(60) Provisional application No. 62/324,447, filed on Apr. 19, 2016.

(51) Int. Cl. B60Q 1/52; G06F 3/023; G06F 3/0482; G06F 3/16

(52) U.S. Cl. CPC B60Q 1/52; G06F 3/167; G06F 3/023; G06F 3/0482

(57) ABSTRACT

An automotive emergency information display method includes the following computer-implemented steps. A user is prompted to enter emergency personal information into a user interface within a motor vehicle. The emergency personal information entered by the user into the user interface is received. It is detected that the motor vehicle has been in a collision. In response to the detecting of the collision, the emergency personal information is displayed within the motor vehicle.

### CROSS-REFERENCE TO RELATED APPLICATION

This application claims benefit of U.S. Provisional Application No. 62/324,447 filed on Apr. 19, 2016, which the disclosure of which is hereby incorporated by reference in its entirety for all purposes.

### FIELD OF THE INVENTION

The disclosure relates to the field of automotive infotainment systems, and, more particularly, to the providing of user information by an infotainment system in a motor vehicle.

### BACKGROUND OF THE INVENTION

Currently, the infotainment systems do not hold any driver/owner information to assist first responders in case of emergency. The driver/owner's mobile phone and/or driver's license number are the available means for the first responders to access and retrieve information about the driver. However, the driver/owner's mobile phone and/or driver's license number may not always be accessible, depending on the situation. In some cases, the owner/user's driver license number may be available to the first responders, but essential medical and emergency contacts information is not available to the first responders.

### SUMMARY

The present invention may make information such as the driver's mobile phone number and driver's license number available in the car using the interface devices already in the vehicle such as on the human machine interface (HMI) screen and over the loudspeakers.

In the event of an accident or other emergency, the invention may make pertinent and critical information available to the first responders in a detailed format via the infotainment system. The invention may save lives in emergency situations. The inventive interface will be available to the first responders when they arrive at the vehicle to provide assistance. When, due to an emergency situation, the owner/driver is not in a physical state such that he is able to provide critical personal information, the most relevant and possibly life-saving information is made readily available to the first responders.

In one embodiment, the invention comprises an automotive emergency information display method including the following computer-implemented steps. A user is prompted to enter emergency personal information into a user interface within a motor vehicle. The emergency personal information entered by the user into the user interface is received. It is detected that the motor vehicle has been in a collision. In response to the detecting of the collision, the emergency personal information is displayed within the motor vehicle.

In another embodiment, the invention comprises an automotive emergency information display arrangement including means for detecting that the motor vehicle has been in a collision. An infotainment system is communicatively coupled to the detecting means and audibly prompts and/or textually prompts a user to enter emergency personal information into a user interface within a motor vehicle. The infotainment system receives the emergency personal information entered by the user into the user interface. The infotainment system responds to the detecting of the collision by displaying the emergency personal information within the motor vehicle.

In yet another embodiment, the invention comprises an automotive emergency information display method including the following computer-implemented steps. A user is prompted to enter emergency personal information into a user interface within a motor vehicle. The emergency personal information entered by the user into the user interface is received. The received emergency personal information is stored in a permanent memory device. An increased likelihood that the user has suffered bodily harm is detected. The detecting of the increased likelihood of bodily harm is responded to by displaying the emergency personal information within the motor vehicle.

### BRIEF DESCRIPTION OF THE DRAWINGS

A better understanding of the present invention will be had upon reference to the following description in conjunction with the accompanying drawings.

FIG. 1 is a flow chart of one embodiment of an emergency information display method of the present invention.

FIG. 2 is a flow chart of another embodiment of an emergency information display method of the present invention.

FIG. 3 is a block diagram of one embodiment of an automotive emergency information display arrangement of the present invention.

FIG. 4 is a flow chart of yet another embodiment of an emergency information display method of the present invention.

### DETAILED DESCRIPTION OF THE PREFERRED EMBODIMENTS

According to one embodiment of a method of the invention, when the infotainment system's hardware first powers up, the user, who may be the owner or driver of the vehicle, may be prompted with an interface which may include a first template having pre-populated fields and a second template which may allow the user to enter free form textual input. The templates may have labels/text fields which enable a user to enter the name/phone number/email address information for a number of people. This contact list may be used to contact and inform the people on the list in case of emergency. The in-case-of-emergency (ICE) information may also come to the infotainment system directly from the user's mobile phone via some protocol like Android Auto, CarPlay, SDL, etc.

The templates may have free text input fields available for the owner/user to enter his personal information such as his name, mobile telephone number, driver's license number, blood type, names of medications that he currently taking, any allergies that he has, and so on.

The input display interface may appear and be shown only the first time the infotainment system's hardware is powered up. The interface may not be displayed upon subsequent power cycling of the infotainment system's hardware. However, the user may be able to access and display the interface via a settings menu on the HMI. After the user has saved the list of his personal information and contact information, the information may be stored into a persistent memory of the hardware. The “settings” option on the HMI menu may enable the user to enter the inventive interface to add to, edit and/or delete the information that he previously entered. Upon the normal power cycle, this interface may not be displayed to the user if he does not access the information through the “settings” option.

In the event of an emergency/collision, in response to the vehicle detecting that the driver-side air bag has been activated, the emergency information that the user supplied may be presented on a default display on the screen. In addition, the emergency information that the user supplied may be audibly read out aloud or spoken over the vehicle's loudspeakers.

The persistent storage of the user-entered information can be continued even when the vehicle is damaged. Accordingly, the storage of the user's emergency information is similar to the storage of information on the black box of an airplane.

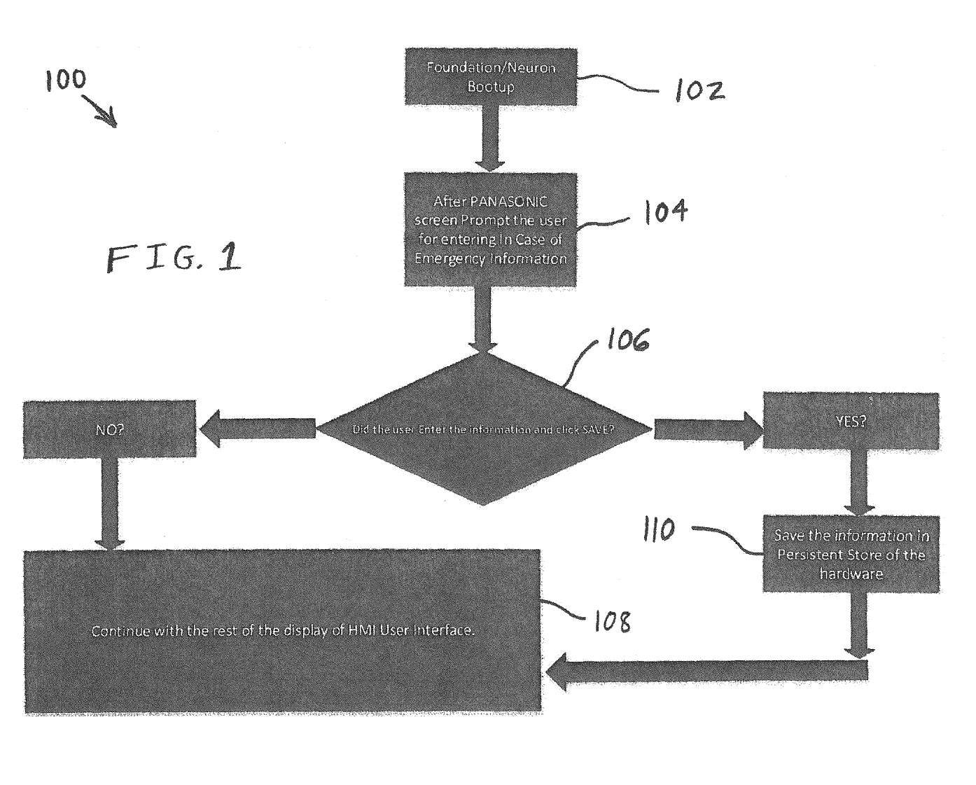

FIG. 1 illustrates one embodiment of an emergency information display method 100 of the present invention. In a first step 102, the infotainment system is booted up. It may be the first time that the infotainment system has ever been powered up, or it at least may be the first time that the infotainment system has been powered up since being acquired by a new user.

In a next step 104, after an optional introductory screen, the display screen and possibly the audio system loudspeakers may prompt the user to enter his emergency personal information (e.g., his name, age, driver's license number, mobile telephone number, names and contact information of people to notify in the event of an emergency, drugs he is taking, allergies he has) into the infotainment system. The user may enter his emergency personal information by voice and a microphone, or via a keyboard of the user interface of the infotainment system. Alternatively, the user's emergency personal information may be automatically received from the user's mobile telephone. Feedback for the user's inputs may be provided on the display screen, and possibly audibly via the loudspeakers.

Next, in step 106, it is determined whether the user has entered his emergency personal information and attempted to save the information in the memory associated with the infotainment system. If not, then after a predetermined time period sufficient for the user to have done so, operation proceeds to step 108 where the HMI user interface resumes its normal presentations on the display screen without reference to the emergency information. On the other hand, if it is determined in step 106 that the user has indeed entered his emergency personal information and attempted to save the information, then in step 110 the information is stored in permanent memory of the infotainment system. Operation then proceeds to step 108 where the HMI user interface resumes its normal presentations on the display screen without reference to the emergency information.

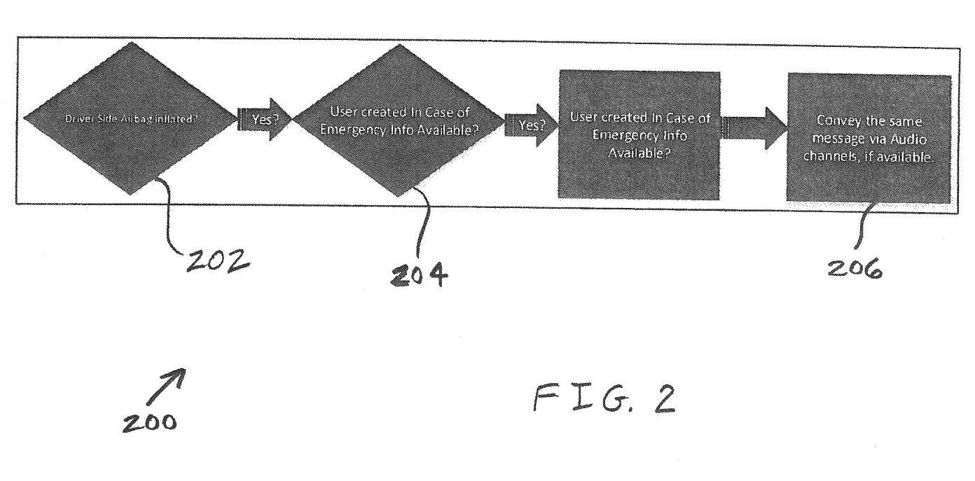

FIG. 2 illustrates another embodiment of an emergency information display method 200 of the present invention. In a first step 202, it is determined whether the driver-side air bag of the vehicle has been inflated, such as a result of the vehicle being in a collision. If so, it is determined in step 204 whether emergency personal information has been entered by the user into the infotainment system and is available. If so, then the emergency personal information is visually displayed on the display screen, and may be audibly spoken on the loudspeakers of the vehicle's audio system.

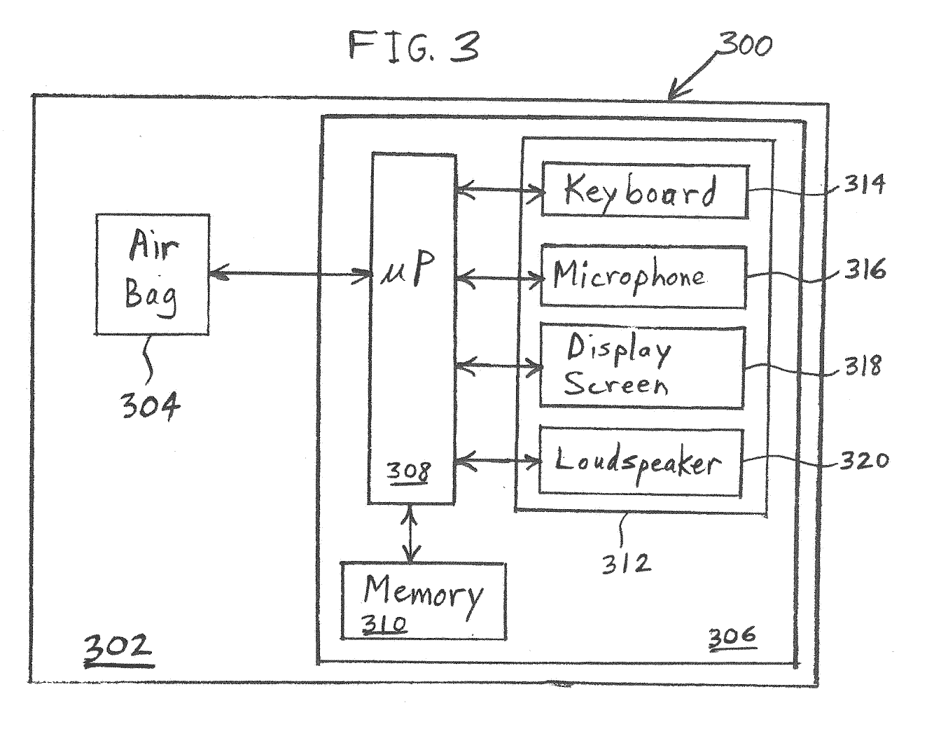

FIG. 3 illustrates one embodiment of an automotive emergency information display arrangement 300 of the present invention disposed in a motor vehicle 302, including an air bag 304 and an infotainment system 306. Infotainment system 306 includes an electronic processor 308, a memory device 310, and a user interface 312 having a keyboard 314, a microphone 316, a display screen 318 and a loudspeaker 320. Arrangement 300 may be suitable for use in any of the methods described above and below, including methods 100, 200 and 400.

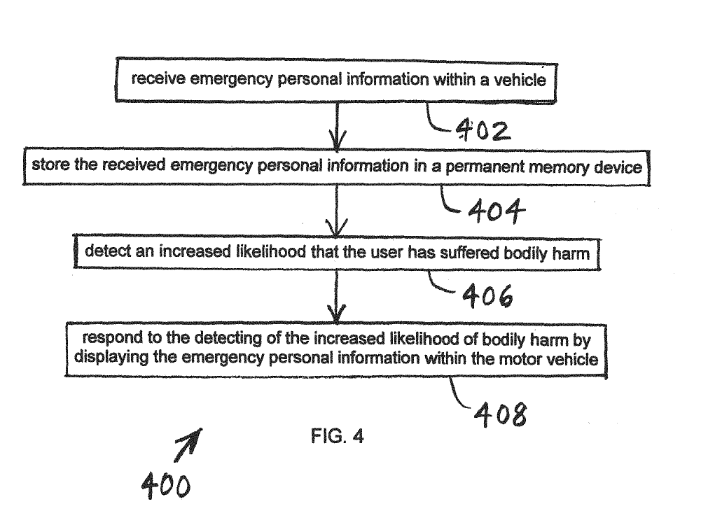

FIG. 4 illustrates yet another embodiment of an emergency information display method 400 of the present invention. In a first step 402, emergency personal information is received within a vehicle. For example, in response to prompting, a user of the vehicle may use keyboard 314 and/or microphone 316 to enter his emergency personal information, such as his name, age, street address, driver's license number, mobile telephone number, names and contact information of people to notify in the event of an emergency, drugs he is taking, substances he has allergies to, medical conditions or diseases he has, and/or contact information for his medical doctor/primary physician. Some or all of such emergency personal information may be automatically wirelessly received from the user's smartphone, personal computer, or other computing device.

Next, in step 404, the received emergency personal information is stored in a permanent memory device. For example, the user's emergency personal information may be stored in memory device 310.

In a next step 406, an increased likelihood that the user has suffered bodily harm is detected. For example, the vehicle may sense that a driver's side air bag has been deployed, or that the vehicle has been in a collision. Alternatively, sensors within the vehicle may monitor the vital signs and bodily functions of the driver. If any of these vital signs or bodily functions are found to be outside of the normal range, then it may be indicative of the driver having suffered bodily harm, possibly due to a serious medical problem. In such circumstances, first responders may find the driver unconscious or unresponsive within the vehicle.

In a final step 408, the detecting of the increased likelihood of bodily harm is responded to by displaying the emergency personal information within the motor vehicle. For example, the driver's emergency personal information may be retrieved from memory device 310 and processed by processor 308. Processor 308 may then present the driver's emergency personal information on display screen 318.

The invention has been described herein as presenting the emergency information in response to detecting that the vehicle has been in a collision. However, the emergency information may also be presented in response to detecting that the user is ill or has been at least temporarily disabled in some way by a medical malady. The vehicle may include eye sensors, motion sensors, pulse sensors, heart rate sensors, etc. in order to detect such illness or medical malady.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An automotive emergency information display method, comprising the computer-implemented steps of:
prompting a user to enter emergency personal information into a user interface within a motor vehicle;
receiving the emergency personal information entered by the user into the user interface;
detecting that the motor vehicle has been in a collision; and
responding to the detecting of the collision by displaying the emergency personal information within the motor vehicle.

2. The method of claim 1 wherein the emergency personal information includes the user's mobile telephone number, the user's driver's license number, and/or contact information for people who the user requests be notified in the event of an emergency.

3. The method of claim 1 wherein the user interface is included in an infotainment system of the motor vehicle.

4. The method of claim 1 wherein the emergency personal information is entered by the user into the user interface by use of a keyboard.

5. The method of claim 1 wherein the emergency personal information is entered by the user into the user interface by use of a microphone.

6. The method of claim 1 wherein the detecting that the motor vehicle has been in a collision includes sensing that an airbag of the motor vehicle has been deployed.

7. The method of claim 1 wherein the emergency personal information is displayed on a display screen of an infotainment system of the motor vehicle.

8. The method of claim 1 comprising the further step of responding to the detecting of the collision by audibly playing the emergency personal information in spoken form on a loudspeaker within the motor vehicle.

9. The method of claim 1 wherein the prompting is performed upon an initial powering up of an infotainment system of the motor vehicle or in response to the user selecting a predetermined option of a user menu on the infotainment system, and the prompting is not performed upon each powering up of the infotainment system.

10. The method of claim 1 comprising the further step of storing the received emergency personal information in a persistent memory.

11. An automotive emergency information display arrangement, comprising:
means for detecting that the motor vehicle has been in a collision; and
an infotainment system communicatively coupled to the detecting means and configured to:
audibly prompt and/or textually prompt a user to enter emergency personal information into a user interface within a motor vehicle;
receive the emergency personal information entered by the user into the user interface; and
respond to the detecting of the collision by displaying the emergency personal information within the motor vehicle.

12. The arrangement of claim 11 wherein the emergency personal information includes the user's mobile telephone number, the user's driver's license number, and/or contact information for people who the user requests be notified in the event of an emergency.

13. The arrangement of claim 11 wherein the user interface is included in the infotainment system of the motor vehicle.

14. The arrangement of claim 11 wherein the infotainment system includes a keyboard, and the emergency personal information is entered by the user into the user interface by use of the keyboard.

15. The arrangement of claim 11 wherein the infotainment system includes a microphone, and the emergency personal information is entered by the user into the user interface by use of the microphone.

16. The arrangement of claim 11 wherein the detecting means includes an airbag of the motor vehicle.

17. The arrangement of claim 11 wherein the infotainment system includes a display screen, and the emergency personal information is displayed on the display screen.

18. The arrangement of claim 11 wherein the infotainment system is configured to respond to the detecting of the collision by audibly playing the emergency personal information in spoken form on a loudspeaker within the motor vehicle.

19. The arrangement of claim 11 wherein the prompting is performed upon an initial powering up of the infotainment system or in response to the user selecting a predetermined option of a user menu on the infotainment system, and the prompting is not performed upon each powering up of the infotainment system.

20. An automotive emergency information display method, comprising the computer-implemented steps of:
prompting a user to enter emergency personal information into a user interface within a motor vehicle;
receiving the emergency personal information entered by the user into the user interface;
storing the received emergency personal information in a permanent memory device;
detecting an increased likelihood that the user has suffered bodily harm; and
responding to the detecting of the increased likelihood of bodily harm by displaying the emergency personal information within the motor vehicle.

21. The method of claim 20 wherein the emergency personal information includes the user's mobile telephone number, the user's driver's license number, and/or contact information for people who the user requests be notified in the event of an emergency.

22. The method of claim 20 wherein the user interface is included in an infotainment system of the motor vehicle.

23. The method of claim 20 wherein the emergency personal information is entered by the user into the user interface by use of a keyboard.

24. The method of claim 20 wherein the emergency personal information is entered by the user into the user interface by use of a microphone.

25. The method of claim 20 wherein the detecting of the increased likelihood that the user has suffered bodily harm includes sensing a change in a bodily function of the user or of a state of the body of the user.

26. The method of claim 20 wherein the emergency personal information is displayed on a display screen of an infotainment system of the motor vehicle.

27. The method of claim 20 comprising the further step of responding to the detecting of the increased likelihood that the user has suffered bodily harm by audibly playing the emergency personal information in spoken form on a loudspeaker within the motor vehicle.

28. The method of claim 20 wherein the prompting is performed upon an initial powering up of an infotainment system of the motor vehicle or in response to the user selecting a predetermined option of a user menu on the infotainment system, and the prompting is not performed upon each powering up of the infotainment system.

29. An automotive emergency information display method, comprising the computer-implemented steps of:
receiving emergency personal information within a motor vehicle, the emergency personal information being received from a user's mobile electronic device;
storing the emergency personal information in a memory device associated with the motor vehicle;
detecting that the motor vehicle has been in a collision; and
responding to the detecting of the collision by presenting the emergency personal information within the motor vehicle.

30. The method of claim 29 wherein the emergency personal information is received by the motor vehicle directly from the user's mobile phone via an Android Auto protocol, a CarPlay protocol, or an SDL protocol.
